(19) United States
(12) Patent Application Publication
(10) Pub. No.: US 2015/0258580 A1
(43) Pub. Date: Sep. 17, 2015

(54) METHOD AND DEVICE FOR CLEANING AND/OR DESINFECTING SURFACES

(71) Applicant: ZOBELE ESPAÑA, S.A.,, Barcelona (ES)

(72) Inventors: Dominic Doyle, Barcelona (ES); Julio Ruiz Ballesteros, Barcelona (ES)

(21) Appl. No.: 14/433,319

(22) PCT Filed: Sep. 26, 2013
(86) PCT No.: PCT/EP2013/070072

§ 371 Date: Apr. 2, 2015

(30) Foreign Application Priority Data
Oct. 4, 2012 (EP) 12187190.9

(51) Int. Cl. B08B 3/02; B08B 3/08

(52) U.S. Cl. CPC B08B 3/026; B08B 3/08

(57) ABSTRACT

The present invention relates to a device for cleaning and/or disinfecting surfaces, particularly for cleaning inner surfaces of the toilet bowl. The device comprises an elongated housing connected to a bottle with the cleaning and/or a disinfecting liquid, and a pumping mechanism for pressurizing said liquid composition, and at least one nozzle for the output of said liquid composition, wherein the nozzle is in fluid communication through a conduit of the device with said pumping mechanism. The pumping mechanism is provided at one side of said housing and said at least one nozzle is provided at the opposite side of the housing.

### OBJECT OF THE INVENTION

The present invention relates to a device for cleaning and/or disinfecting surfaces and particularly but not exclusively, for cleaning inner surfaces of the toilet bowl, including under the toilet bowl rim, and treating toilet bowl surfaces to remove contaminants, bacteria and/or malodour as well as introduce a treatment agent and/or air freshening agent thereto.

### BACKGROUND OF THE INVENTION

Toilet bowls are generally connected to water supply connections, and flushing a toilet bowl can be accomplished automatically or by pressing a handle. However, the stain and the bad odour of a toilet bowl cannot be eliminated by flushing with clean water. The effect from flushing with clean water is usually not remarkable.

Toilet bowls require care to prevent the buildup of deposits and/or bacteria growth and to reduce bad odors. Traditionally, toilet bowls are cleaned and disinfected manually with cleaning and/or sanitizing agents and manual hand work. This is a hard and not desirable labor that people don't like.

In order to eliminate this undesirable task various toilet bowl cleaners have been proposed in the past, for example U.S. Pat. No. 4,777,670. In fact are well known in the market the products used for toilet cleaning and disinfection that avoid manual scrubbing. One type of dispenser comprises a solid block of cleansing and freshening substances that are suspended from the rim of a toilet bowl in a container that is placed in the path of the flushing water. A portion of the solid block is delivered into the toilet every flushing.

Other toilet bowl cleaning solutions use a liquid cleaning substance that is delivered into the toilet bowl. For example U.S. Pat. No. 6,178,564 and U.S. Pat. No. 6,230,334, and PCT International Publication Nos. WO 99/66139 and WO 99/66140 all devices or substances that are capable of being suspended from the rim of a toilet bowl.

Other toilet bowl devices use an aerosol that is delivered through a conduit attached to the toilet bowl rim. For example U.S. Pat. No. 3,178,070.

Trigger-sprayer bottles represent a very recognizable packaging for spray cleaning products. Trigger sprayers were developed decades ago by companies as AFA Corp, Owens, and Calmar, and now these sprayers are very conventional and familiar, available at low cost from many distributors. Usually these devices are a combination of a blow-molded bottles, with conventional trigger sprayer, and a straw-type dip-tube positioned down into the bottle. However, these devices cannot be used to spray in areas as under toilet bowl rim due to his ergonomie. As a possible solution inverted spraying has been described in the prior art. For example U.S. Pat. Nos. 6,293,441 (Tasaki et al.); 5,979,712 (Montaner et al.); 5,775,548 (Hohmann et al.) and WO2011/090823 (PCT/US2011/020304) each describe invertible sprayers.

Although, as we have seen, there are various treatments, devices and systems commercially available to address the root of the toilet cleaning, the present invention is concerned with a cost-effective device that is capable of delivering a cleaning and/or refreshing and/or sanitizing substance in a upright position, wherein the device is configured to be operated more efficiently to improve the cleaning, it is more user convenient and more efficient that previous devices.

Drawbacks of the existing solutions that will be solved with our invention:

An embodiment of a toilet cleaner device as is set forth in the foregoing is known from U.S. Pat. No. 5,611,465. The known toilet cleaning device constitutes an integrated device having an automatic liquid soap dispenser and a guided flow tube. The dispenser is provided with a timer-activated device, and the guided flow tube is connected to the water supply connection of the toilet bowl. The liquid soap is squeezed through the guided flow tube into the water supply connection, thereby allowing the water to be mixed with the liquid soap for flushing and cleaning the toilet bowl.

It is a disadvantage of the known toilet cleaner device that in order to do his task it works automatically that means to lose efficiency. Several doses could be applied one over the other without flushing, just wasting a lot of active substance and harming the environment.

Other solutions as proposed on U.S. Pat. No. 4,777,670, U.S. Pat. No. 6,178,564 and U.S. Pat. No. 6,230,334, and PCT International Publication Nos. WO 99/66139 and WO 99/66140, are toilet rim mounted and they have not access with the chemical ingredients to hidden surfaces in the toilet bowl reducing dramatically the efficacy of the solution. The present invention is user-controlled, and for this reason the user can apply the chemical agent in the area where bacteria's or contaminants are building up.

Other solutions as U.S. Pat. No. 8,220,080 they have not solution for user interaction with the device in case that device is fit permanently or temporally inside the toilet bowl or device could be in contact with dirty and/or unsafe and/or unsanitized areas. The present invention has specific solutions in order user is not forced to touch product areas that have been in contact with unsafe toilet bowl surfaces due to his upright position use.

### DESCRIPTION OF THE INVENTION

It is an object of the invention to provide a cleaning and/or disinfecting device efficient, effective and user convenient that can works in an upright position, with the trigger system in the upper part of the device and the chemical output close to the bottom side of the device.

It is a still further object of the invention to provide a device for cleaning inner surfaces of toilet bowl and treating toilet bowl surfaces to remove contaminants, bacteria and/or malodour as well as introduce a treatment agent and/or air freshener thereto.

To this end the device according to the invention comprises:
A handle to hold the device;
a trigger to activate the delivering of the substance,
a fluid dispensing pump that may be used to pump fluid from a container to the sprayer of the invention.
a sprayer,
a container for the chemical substance that will be delivered,
A protection for childproof use.

The device has an ergonomic handle that allows to be used only with one hand. The manual trigger is placed in a position just to avoid user to put the hand inside the toilet.

The container has a relatively flat bottom that allows maintaining the device upright. The bottom of the container is in contact with the surface over the device is rested. The sprayer is allocated near the bottom side but not in contact with the surface over the devise is rested.

The fluid container is replaceable.

When an user presses the trigger, the fluid dispensing pump sucks the liquid from the container and send it, thought a pipe, to the sprayer.

Key Aspects:

The invention has the trigger system and the handle support in the upper part of the device with the chemical output in the bottom side of the product, just to be used in a upright position improving the efficacy, performance and usability thanks to this ergonomic design that allow to spray directly over the dirty and hidden areas of the toilet bowl without to introduce the user hands inside the said toilet bowl.

Then invention could have the sprayer 90° direction from the trigger movement for user convenience (usability)

The invention could have a system to avoid that user can refill the fluid container

The invention could have a system to remove the fluid container without to touch it.

The invention could be used by user in terms to deliver chemical agent in any part of the toilet bowl: Any point above the toilet waterline, any point at the toilet waterline, and/or locations under the toilet.

The invention could have a special spraying pattern that helps the user to cover 100% of the inner surface of toilet bowl.

The invention could have a fluid dispensing pump that can deliver liquids with a very good repeatability, consistency and long life for best efficacy and efficiency of the product.

The invention could have a system to avoid the leakage of the bottle if the device is used up-side-down.

The invention could have a system for childproof protection.

The invention can mist, spray and/or foam the chemical product by a selector.

The invention can include a detachable brush accessory

The invention can include a folding nozzle cover to avoid user contact and dripping.

Keeping the sprayer in the bottom of device is considered to be particularly advantageous and efficient for several reasons, in particular because user can operate device stand-up in a very ergonomic position. Additionally this position improves the efficacy of the product due to the fact that is possible to spray directly onto the dirty deposits or hidden surfaces areas that are good spaces for bacteria growing.

Preferably the device is manually operated, but alternatively or additionally device could be battery operated with a motorized pump.

Preferably the device has the trigger in the opposite side of the sprayer just to avoid putting the user hand inside the toiled bowl when device operated.

Preferably the liquid container could be replaced when liquid finished.

Preferably the sprayer is perpendicular to the trigger movement direction in order to have an easy dosing on the toiled bowl rim area.

Preferably the sprayer has 3 nozzles in order to reach maximum breadth angle and minimize the number of triggers needed to cover all inside toilet areas. Alternatively 1 nozzle special fan spray pattern will be used.

Users don't want to touch devices areas that have been inside the toilet bowl or in contact with it. Due to the fact that bottle could be in contact with toilet bowl water or toilet bowl surfaces when device in use, is particularly advantageous that the device has a user interface system to detach the container when empty without the need to touch it.

It is preferable to have a pipe from the bottom of the recipient to the pumping system, to facilitate the full emptying of the recipient. Alternatively a recipient with a special output valve and a double internal layer, example bag-in a-bag could be used avoiding the pipe and improving features as the possible leakage of the product.

User observation indicates that sometimes user refill an empty bottle with other chemical liquids. This is a very dangerous practice due to the fact that they can put inside the device a dangerous liquid.

It is preferable to have a mechanical system to avoid that an empty and removed container could be placed again in the device. Container could have a thread that will be broken after be put inside the device. When container removed the threat will be useful for another use.

It is preferable that each activation generates a spray, but alternatively is possible to have a solution where the refill is pressurized, with gas mixed or not with chemical agent, and one trigger activation can deliver several seconds of liquid dosing.

It is preferable that each activation generates a spray, but alternatively is possible to mist or foam the chemical product.

It is preferable that device only spray, but alternatively is possible that device has a detachable or fixed brush accessory.

User insights show that avoid child use of this kind of products is very important for users and consumers due to the fact that this substances are very dangerous for children. Then preferable that product has a child safe system at the sprayer output to close it and avoid spraying. Alternatively or additionally is possible to have a mechanical system to avoid trigger activation by children. Alternatively is possible a mechanical system in the nozzle to avoid children activation.

### DESCRIPTION OF THE DRAWINGS

FIG. 1.—is a cross-sectional elevated view of a preferred embodiment of the invention.

FIG. 2.—is a perspective view of the trigger.

FIG. 3. is a pair of view of the nozzle spray output

FIG. 4.—is a perspective view of a nozzle detail with a wide spraying pattern.

FIG. 5.—is a perspective view of the pumping system

FIG. 6.—is a perspective view of the container.

FIG. 7.—is a set of perspective views showing the recipient replacement.

FIG. 8.—is a cross-section al view of the mechanical solution for avoiding user refilling and bottle leakage.

FIG. 9.—is a perspective view

### PREFERRED EMBODIMENTS OF THE INVENTION

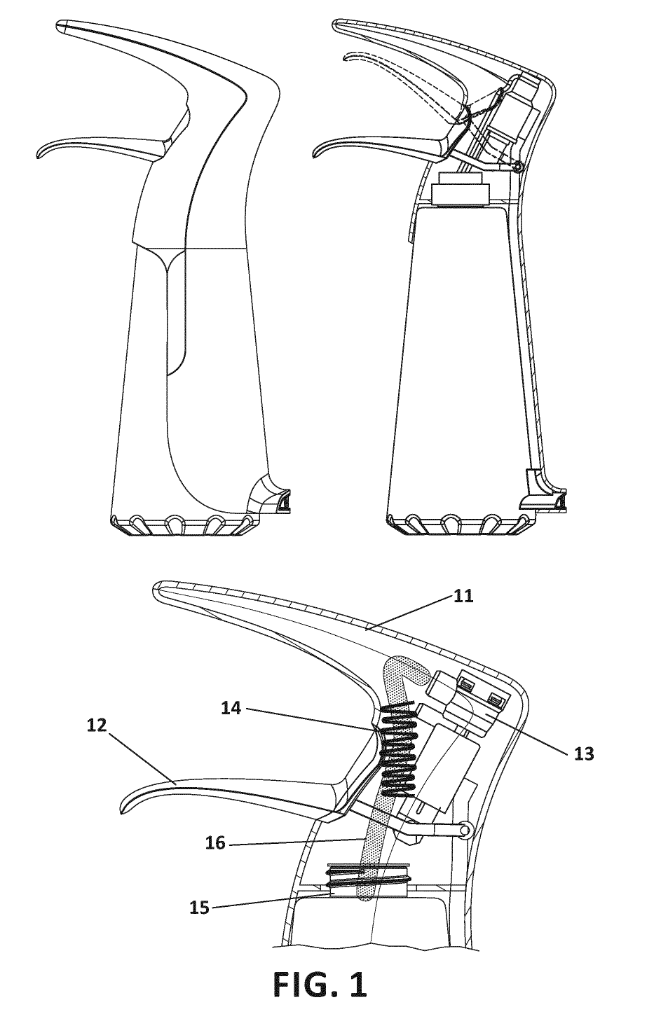

FIG. 1 presents a possible realization of the handle 11 and the trigger 12 used by user to dispense chemical product. When user presses the trigger 12 just hanging the device with one hand by the handle 11, the internal pump 13 system is activated. The chemical is carried from the container 15, through a pipe 16, to the pump 13 and at the same time from the pump 13 to the nozzle output, and finally it is sprayed.

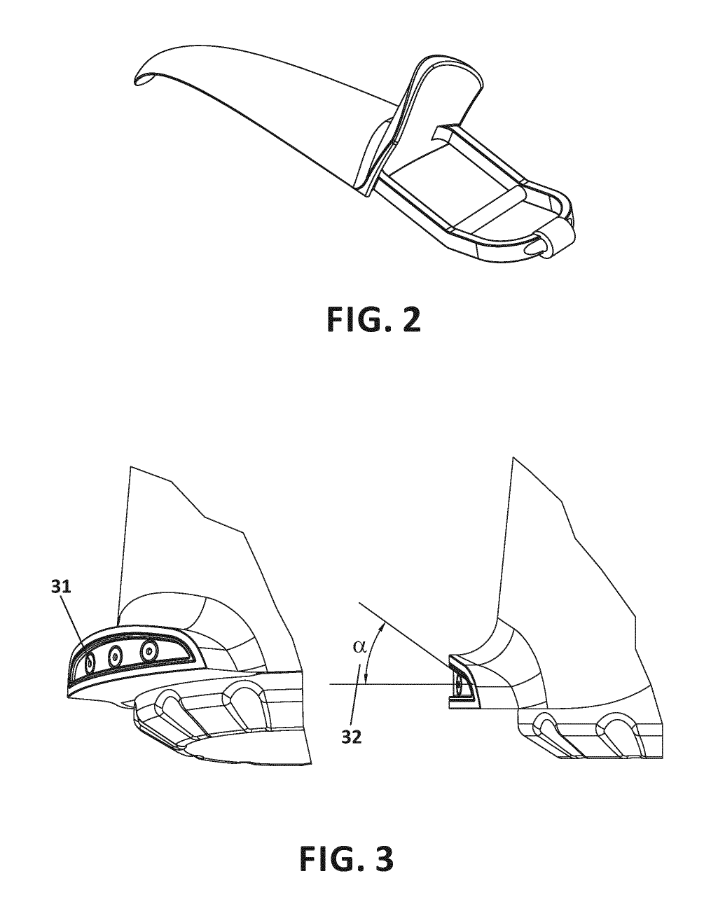

FIG. 2 illustrates a detail of the trigger arm part.

FIG. 3 illustrates a detail of the 3 nozzles output 31. In different implementations of the product the nozzles could be in a different angle position 32 from the horizontal.

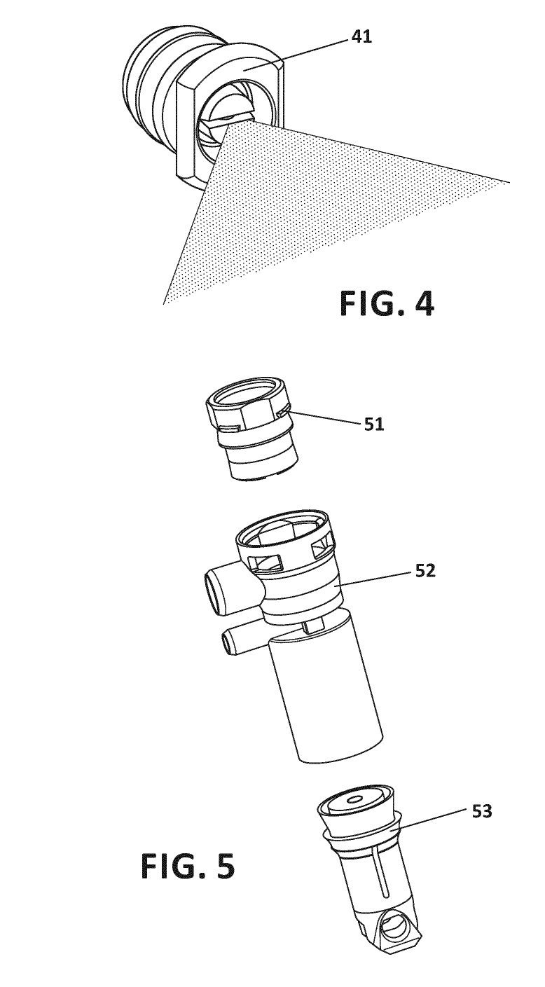

FIG. 4 presents a detail for the spray chemical output. The nozzle 41 could have a wide spraying pattern that will allow to dose to the maximum possible surface during each activation, reducing dramatically the number of activations that one user need to do to dispense the chemical in the entire internal toilet bowl surface.

FIG. 5 presents a possible solution for the pumping system, based into a plastic body 52, a valve 51 and a piston 53.

FIG. 6 presents a possible solution for the container done with a blow-moulded plastic bottle 63. Container has a thread 61 in the top and a special grip, to hold the bold when disconnecting from the dispenser, in the bottom 62.

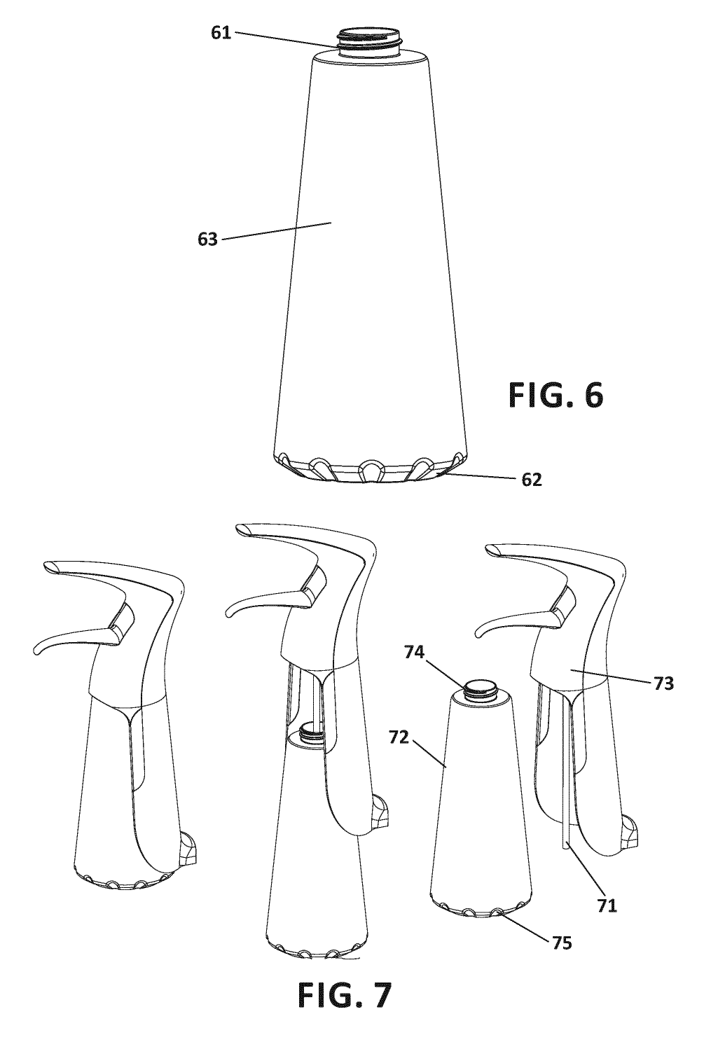

FIG. 7 presents how empty container is replaced in the device. First user will unscrew the recipient 72 from the device 73 just taking the container from the bottom grip 75 and turning anti-clockwise. After removing the empty container a full one must be put just introducing the pipe 71 inside the container 72, placing the container and screwing it in clockwise direction.

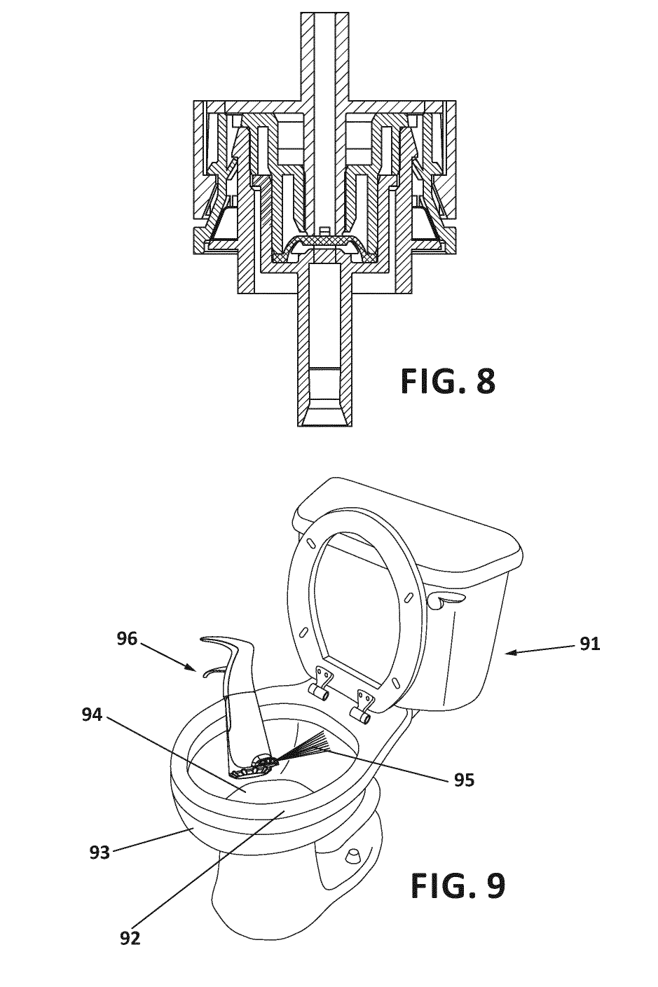

FIG. 8 presents a mechanical solution for avoiding user refilling and bottle leakage.

FIG. 9 illustrates the ability of the cleaning system to spray up underneath the rim 92 of a toilet bowl 93. The unique packaging and ergonomic shape of the present invention allows the upright spray of product 95 even though the user doesn't need to put the hand inside the toilet. This shape is necessary to avoid collision between the body of the recipient 96 and the toilet bowl 93, and to keep the package out of the toilet 91 and far away from the toilet water 94. The spray nozzle allows for the spray 95 to be upwards at a sharp angle and sprayed from a point inside the bowl of the toilet. The present cleaning system may be used to clean all the other exterior and interior parts of the toilet 91 by spraying upright and optimizing a standing position of user.

1. A device for cleaning surfaces, comprising an elongated housing (73) connected to a bottle (72), wherein the bottle (72) contains a cleaning and/or a disinfecting liquid composition (95), the device further comprising a pumping mechanism (13) for pressurizing said liquid composition, and at least one nozzle (31) for the output of said liquid composition (95), wherein the nozzle (31) is in fluid communication through a conduit (71) of the device with said pumping mechanism (13) and wherein the pumping mechanism (13) is provided at one side of said housing (73) and said at least one nozzle (31) is provided at the opposite side of the housing (73), characterised in that the pumping mechanism (13) comprises a trigger (12) to activate the pressurizing of the liquid composition (95) and a handle system (11) to hold the device, and wherein the at least one nozzle (31) is arranged such as the angle (32) of the direction of the expelled liquid composition (95) upon operation of the pumping mechanism (13), is from about 0° to about 85° downward and/or upward from a horizontal plane when the bottle (72) rests flat on a horizontal surface.

2. The device for cleaning surfaces according to claim 1, characterized in that the bottle (72) is detachably connected to the housing (73).

3. The device for cleaning surfaces according claim 1, characterized in that the device comprises two or more nozzles that can cover maximum surface each activation.

4. The device for cleaning surfaces claim 1, characterized in that the device comprises a refill change system to avoid user to contact the possible dirty bottle.

5. The device for cleaning surfaces claim 1, characterized in that the device can spray, mist or foam the liquid composition.

6. The device for cleaning surfaces according claim 1, characterized in that the bottle cannot be refilled or reused.

7. The device for cleaning surfaces according to claim 1, characterized in that the device has a childproof closure to avoid that child can access and/or be in contact with the liquid composition.

8. The device for cleaning surfaces claim 1, characterized in that the device has also a detachable brush accessory.

9. The device for cleaning surfaces according to claim 1, wherein the device comprises a system to avoid the leakage of the container.

10. The device for cleaning surfaces according to claim 1, wherein the device comprises a folding nozzle cover to avoid user contact and dripping.

11. A device for cleaning surfaces adapted for cleaning inside of a toilet bowl.

12. The device according to claim 1, wherein the bottle has a substantially flat surface suitable configured for maintaining the device upright on a surface when the container is in contact with that surface.

13. A method for cleaning the inside of a toilet bowl with the cleaning system of claim 1, said method comprising the steps of:
obtaining the cleaning system of claim 1
holding said cleaning system and introducing the bottom area of it inside the bowl such that said sprayer output is below the level of the rim of the toilet; and
spraying said chemical product inside the bowl and along the sides of the toilet bowl;
optionally brushing said toilet bowl with a brush that could be included or not in the cleaning system,
flushing the toilet to rinse away said composition;
alternatively the chemical product could be left from 5 seconds to 60 minutes inside the toilet before to flush it in order to improve the cleaning performance.
